(19) United States
(12) Patent Application Publication
(10) Pub. No.: US 2009/0073911 A1
(43) Pub. Date: Mar. 19, 2009

(54) FEEDBACK METHOD FOR MULTICAST SERVICE IN WIRELESS COMMUNICATION SYSTEM, AND A SYSTEM IMPLEMENTING THE METHOD

(75) Inventors: Jung-Hoon CHEON, Suwon-si (KR); Jong-Hyung KWUN, Seongnam-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/212,536

(22) Filed: Sep. 17, 2008

(30) Foreign Application Priority Data
Sep. 18, 2007 (KR) 2007-0094932

(51) Int. Cl. H04J 15/00

(52) U.S. Cl. 370/312

(57) ABSTRACT

A method for providing multicast service by a base station in a wireless communication system and a system implementing the method are provided. The method includes receiving one or more multicast service request messages including downlink channel state information from one or more mobile stations, determining the number of mobile stations which have requested a multicast service, determining a modulation and coding scheme (MCS) based on a mobile station, which has transmitted lowest channel quality information, among the one or more mobile stations when the determined number of mobile stations exceeds a preset value, and providing the multicast service through a t^{th} frame by applying the determined MCS. Accordingly, the multicast service is provided by taking a channel state into consideration to improve the utilization of wireless resources.

### PRIORITY

This application claims the benefit under 35 U.S.C. § 119(a) of a Korean patent application filed in the Korean Intellectual Property Office on Sep. 18, 2007 and assigned Serial No. 2007-94932, the entire disclosure of which is hereby incorporated by reference.

### BACKGROUND OF THE INVENTION

1. Field of the Invention

The present invention relates to a wireless communication system. More particularly, the present invention relates to a method of performing feedback for multicast service provided from a base station by a mobile station in a wireless communication system, and a system implementing the method.

2. Description of the Related Art

A broadcast service refers to a technology in which a transmission terminal transmits a control message and/or data traffic to a plurality of unspecified reception terminals. The transmission terminal includes a base station (BS), and the reception terminal includes a mobile station (MS). The base station provides broadcast service by using a modulation and coding scheme (MCS) level, at which mobile stations located in a cell-boundary region can receive a signal.

FIG. 1 is a view illustrating a channel state of a mobile station located near a base station in a conventional wireless communication system

Referring to FIG. 1, the base station transmits a signal by applying the lowest MCS level to allow the signal to arrive at a cell-boundary region, even when all mobile stations to receive a broadcast service are located near the base station and are in a good channel state. The signal using the lowest MCS level is robust to channel variations, but is inefficient in terms of resource utilization.

Meanwhile, a multicast service refers to a technology in which a base station transmits a control message and/or data traffic to a plurality of specified mobile stations. Conventionally, for a multicast service, Multimedia Broadcast Multicast Service (MBMS) and Broadcast Multicast Service (BCMCS) are defined by the 3^{rd} Generation Partnership Project (3GPP) and 3GPP2. However, in the specifications defined for the MBMS and BCMCS, there is no method for enabling a base station to determine if at least one mobile station normally receives multicast data traffic. In addition, a method for enabling the base station to provide multicast service according to the channel state of the at least one mobile station has not been defined.

### SUMMARY OF THE INVENTION

An aspect of the present invention is to address at least the above-mentioned problems and/or disadvantages and to provide at least the advantages described below. Accordingly, an aspect of the present invention is to provide a method for efficiently providing multicast service by taking a downlink channel state into consideration in a wireless communication system, and a system implementing the method.

In addition, an aspect of the present invention is to provide a multicast service providing a method for minimizing a waste of wireless resources in a wireless communication system, and a system implementing the method.

In accordance with an aspect of the present invention, a method for performing feedback for multicast service by a mobile station in a wireless communication system is provided. The method includes transmitting a multicast service request message including downlink channel state information to a base station, determining t^{th} a signal corresponding to a multicast service is received from the base station through a t^{th} frame, if the signal corresponding to the multicast service is not received, transmitting a Negative Acknowledgement (NACK) message to the base station in a contention-based scheme through a (t+1)^{th} frame, receiving a signal re-transmitted from the base station through a (t+₂)^{th} frame, and transmitting a Quality-of-Service (QoS) indicator to the base station in every frame when the downlink channel state is degraded below a preset channel state.

In accordance with still another aspect of the present invention, a method for providing multicast service by a base station in a wireless communication system is provided. The method includes receiving one or more multicast service request messages including downlink channel state information from one or more mobile stations, determining the number of mobile stations which have requested multicast service, determining a modulation and coding scheme (MCS) based on a mobile station, which has transmitted lowest channel quality information, among the one or more mobile stations when the determined number of mobile stations exceeds a preset value, and providing the multicast service through a t^{th} frame by applying the determined MCS.

In accordance with still another aspect of the present invention, a wireless communication system is provided. The system includes at least one mobile station for transmitting a multicast service request message including downlink channel state information to a base station, for determining if a signal corresponding to a multicast service is received from the base station through a t^{th} frame, for transmitting a Negative Acknowledgement (NACK) message to the base station in a contention-based scheme through a (t+1)^{th} frame, if the signal corresponding to the multicast service is not received, for receiving a signal re-transmitted from the base station through a (t+2)^{th} frame, and for transmitting a Quality-of-Service (QoS) indicator to the base station in every frame when the downlink channel state is degraded below a preset channel state, and a base station for receiving one or more multicast service request messages including downlink channel state information from the one or more mobile stations, for determining the number of mobile stations which have requested the multicast service, for determining a modulation and coding scheme (MCS) based on a mobile station, which has transmitted lowest channel quality information, among the one or more mobile stations when the determined number of mobile stations exceeds a preset value, and for providing the multicast service through the t^{th} frame by applying the determined MCS.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 is a view illustrating a channel state of a mobile station located near a base station in a conventional wireless communication system;

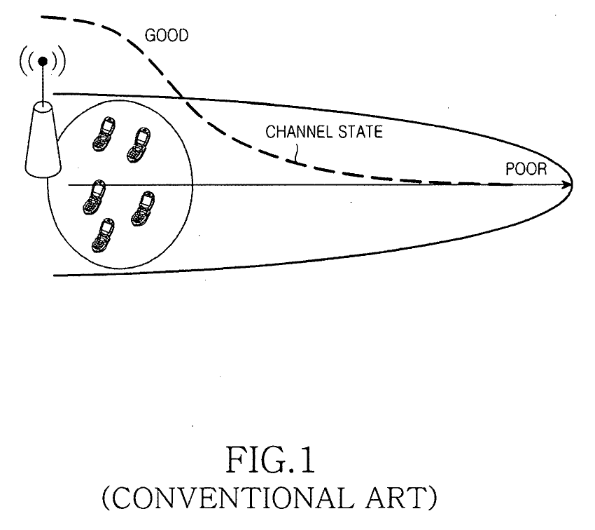

FIG. 2 is a flowchart illustrating an operation of providing a multicast service by a base station according to an exemplary embodiment of the present invention;

FIG. 3 is a flowchart illustrating an operation of performing a feedback for reception of a multicast service by a mobile station according to an exemplary embodiment of the present invention; and

FIG. 4 is a view illustrating a case where a mobile station transmits a QoS indicator to a base station according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention provide a method, in which a base station provides multicast service according to the channel state of a mobile station, and the mobile station performs a feedback for the multicast service in a wireless communication system, and the system.

To this end, exemplary embodiments of the present invention propose three feedback methods for a mobile station. The first method is that a mobile station feeds channel quality information (CQI) back to a base station when requesting multicast service. The second method is that a mobile station feeds a Negative Acknowledgement (NACK) message back to a base station when the mobile station has not normally received multicast data traffic. In this case, the transmission of the NACK message by the mobile station is performed in a contention-based scheme in order to minimize a waste of uplink resources. The third method is that a mobile station feeds a Quality-of-Service (QoS) indicator, that indicates the channel state of the mobile station, back to a base station when the channel state of the mobile station falls below a preset level, and is considered to be a poor channel state. The method for providing multicast service and performing a feedback for the multicast service according to exemplary embodiments of the present invention can be applied all communication systems that provide a multicast service.

In order to achieve the method for providing multicast service and performing a feedback for the multicast service according to exemplary embodiments of the present invention, the following conditions are required.

1. When a mobile station located in a cell recognizes that a multicast service is to be provided from a base station, the mobile station transmits a service subscription request message, e.g. a service join request message, including downlink CQI of the mobile station to the base station.

2. When the base station has received the service join request message including CQI from the mobile station, the base station determines that the mobile station is to join the multicast service.

3. The base station determines one among the multicast service, a broadcast service, and a unicast service according to the number of service subscribers, and can change the type of service by taking into consideration a QoS indicator received from a mobile station while providing the service.

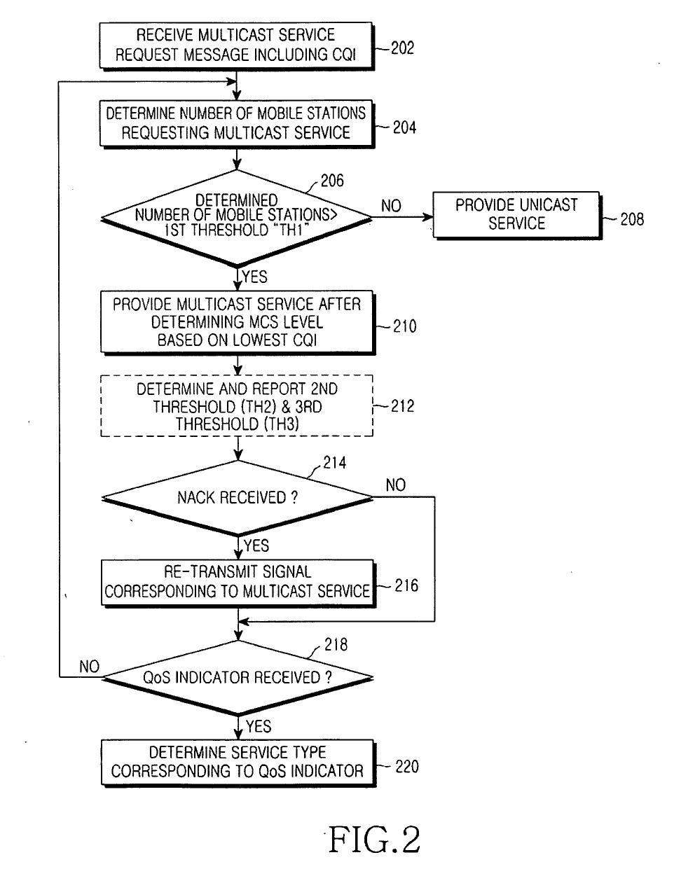

FIG. 2 is a flowchart illustrating an operation of providing a multicast service by a base station according to an exemplary embodiment of the present invention.

Referring to FIG. 2, in step 202, the base station receives a multicast service request message including downlink CQI from a mobile station, and then proceeds to step 204. In step 204, the base station determines a number of mobile stations which have requested the multicast service, and then proceeds to step 206. In step 206, the base station determines if the determined number of mobile stations exceeds a preset first threshold value “TH1.” When the determined number of mobile stations is equal to or less than the first threshold value as a result of the determination, the base station provides service in the unicast scheme to the mobile station, which has requested the multicast service, in step 208. In contrast, when the determined number of mobile stations exceeds the first threshold value, the base station proceeds to step 210. In step 210, the base station determines an MCS level based on a mobile station having fed back the lowest CQI among mobile stations which have requested the multicast service, provides the multicast service to the mobile stations having requested the multicast service, and then proceeds to step 212. Here, the lowest CQI represents the poorest channel state. Meanwhile, when two or more mobile stations have requested the same multicast service, it is preferred in terms of transmission efficiency that service is provided in the multicast scheme.

In step 212, the base station establishes a second threshold value “TH2” and a third threshold value “TH3” according to the channel states of mobile stations receiving the multicast service, notifies the mobile stations of the established threshold values, and then proceeds to step 214. The threshold values may be determined as fixed values upon the initial implementation of the system. In addition, although an exemplary embodiment of the present invention is described regarding the case where a plurality of threshold values have been established at every session opening, so that a plurality of QoS indicators can be separately transmitted according to channel states, certain exemplary embodiments of the present invention may be implemented in such a manner as to establish at least one threshold value to determine if a QoS indicator is to be transmitted. The threshold value may be determined based on the average Signal to Interference and Noise Ratio (SINR) value of mobile stations, movement speeds thereof, etc. If the average SINR value of mobile stations is high, or if a movement speed is higher than a reference speed, the SINR values of some mobile stations may decrease. Therefore, it is efficient to change a feedback transmission time point depending on SINR values by establishing two or more threshold values.

In step 214, the base station determines if the base station has received a contention-based NACK message from at least one mobile station. When the base station has received a NACK message as a result of the determination, the base station re-transmits a signal corresponding to the multicast service, which the base station has transmitted in the previous frame, to all mobile stations to be provided with the multicast service in step 216, and then proceeds to step 218. The multicast service refers to a scheme in which service is provided to a plurality of specified mobile stations. Therefore, when some mobile stations have not received service, it is more efficient to again provide the multicast service to the plurality of specified mobile stations, rather than providing service only to the mobile stations that have not received service.

Meanwhile, when it is determined in step 214 that the base station has not received a NACK message, or when the base station has re-transmitted the signal of the previous frame, the base station determines if the base station receives a QoS indicator from a mobile station in step 218. When the downlink channel state of a mobile station corresponds to an SINR equal to or less than the second threshold value or equal to or less than the third threshold value, the mobile station can transmit a QoS indicator including the current SINR value to the base station. In this case, the QoS indicator may include information about at least one among CQI, a loss rate, jitter, latency and the like. That is, when a multicast service session is opened, each mobile station joining the session determines at least one parameter, among CQI, a loss rate, jitter, latency and the like, to be used as a QoS indicator, and uses information about the determined parameter as the QoS indicator. This is because importance may be attached to different QoS parameters depending on the characteristics of sessions.

Therefore, when the base station receives a QoS indicator from the mobile station, the base station determines a type of service according to the received QoS indicator in step 220. For example, when there is a mobile station which is moving or which requests a high quality of service, the base station may provide the corresponding mobile station with service not in the multicast scheme, but in a unicast scheme. Otherwise, when mobile stations, which are moving, correspond to a partial group included in the entire group receiving service, the base station may perform a sub-grouping operation.

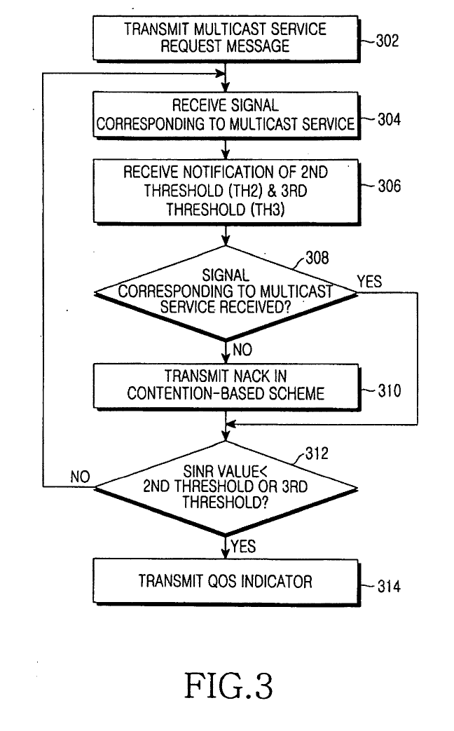

FIG. 3 is a flowchart illustrating an operation of performing a feedback for reception of a multicast service by a mobile station according to an exemplary embodiment of the present invention.

Referring to FIG. 3, in step 302, the mobile station transmits a multicast service request message including downlink CQI to a base station, and then proceeds to step 304. In step 304, the mobile station receives a signal corresponding to a multicast service provided from the base station through a t^{th} frame, and then proceeds to step 306. In step 306, the mobile station is notified of a second threshold value and a third threshold value from the base station, and then proceeds to step 308. Here, similar to step 212 of FIG. 2, step 306 is implemented in only certain exemplary embodiments of the present invention.

In step 308, the mobile station determines if the mobile station receives a signal corresponding to multicast service through a (t+1)^{th} frame. Then, the mobile station proceeds to step 310 if the mobile station does not normally receive the signal as a result of the determination, and the mobile station proceeds to step 312 if the mobile station normally receives the signal as a result of the determination. In step 310, the mobile station transmits a NACK message to the base station under a contention-based circumstance. When the mobile station transmits the NACK message in a contention scheme, as described above, it is possible to minimize a waste of uplink resources. If the base station has successively received NACK messages from a specific mobile station at least two times, the base station must recognize that the channel state of the specific mobile station is very poor, and separately manages the specific mobile station. For example, with respect to a mobile station which is in a very poor channel state, the base station shifts into a unicast mode, or interrupts provision of the multicast service.

Meanwhile, in step 312, the mobile station determines if the downlink SINR has a value less than the second threshold value or less than the third threshold value while the mobile station is receiving signals through each frame or through frames following the (t+1)^{th} frame. When the current downlink SINR has a value less than the second threshold value or less than the third threshold value as a result of the determination, the mobile station transmits a QoS indicator to the base station in step 314. In contrast, when the current downlink SINR has a value equal to or greater than the second threshold value or the third threshold value as a result of the determination, the mobile station returns to step 304.

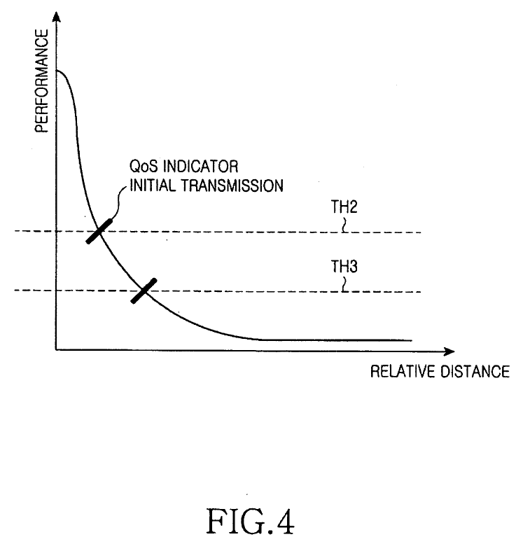

FIG. 4 is a view illustrating a case where a mobile station transmits a QoS indicator to a base station according to an exemplary embodiment of the present invention.

Referring to FIG. 4, the mobile station transmits a QoS indicator to the base station when the downlink SINR has a value less than the second threshold value “TH2.” Thereafter, when the downlink SINR value of the mobile station is further dropped to a value less than the third threshold value “TH3,” the mobile station transmits the QoS indicator once more. As described above, after the mobile station transmits a multicast service request message including CQI, the mobile station can transmit a QoS indicator using a smaller number of bits than that used upon the transmission of the CQI, according to the downlink SINR, the second threshold value, and the third threshold value. Accordingly, the mobile station can greatly reduce consumption of uplink resources, as compared with the case of periodically transmitting CQI. Also, since the base station provides a multicast service by taking into consideration the downlink channel state of each mobile station, a waste of resources can be minimized.

According to exemplary embodiments of the present invention, the base station provides multicast service by taking into consideration downlink channel states of mobile stations, which have requested the multicast service, in a wireless communication system, it is possible to improve the utilization of wireless resources. In addition, when the mobile station receives a multicast service, the mobile station feeds back information about a channel maintenance state or information about whether service is normally received, so that the mobile station can stably receive the service.

While the present invention has been shown and described with reference to certain exemplary embodiments thereof, it will be understood by those skilled in the art that various changes in form and details may be made therein without departing from the spirit and scope of the invention as defined by the appended claims and their equivalents. Accordingly, the scope of the invention is not to be limited by the above exemplary embodiments but by the claims and the equivalents thereof.

What is claimed is:

1. A method for performing feedback for multicast service by a mobile station in a wireless communication system, the method comprising:
determining if a signal corresponding to a multicast service is received from a base station through a t^{th} frame;
if the signal corresponding to the multicast service is not received, transmitting a Negative Acknowledgement (NACK) message to the base station in a contention-based scheme through a (t+1)^{th} frame;
receiving a signal re-transmitted from the base station through a (t+2)^{th} frame; and
transmitting a Quality-of-Service (QoS) indicator to the base station in every frame when the downlink channel state is degraded below a preset channel state.

2. The method as claimed in claim 1, further comprising receiving information about the preset channel state from the base station.

3. The method as claimed in claim 1, wherein the QoS indicator includes a parameter associated with at least one of channel state information, a data loss rate, jitter, and latency.

4. A method for providing multicast service by a base station in a wireless communication system, the method comprising:
receiving one or more multicast service request messages including downlink channel state information from one or more mobile stations;
determining the number of mobile stations which have requested multicast service;
determining a modulation and coding scheme (MCS) based on a mobile station, which has transmitted lowest channel quality information corresponding to the poorest channel state, among the one or more mobile stations when the determined number of mobile stations exceeds a preset value; and
providing the multicast service through a t^{th} frame by applying the determined MCS.

5. The method as claimed in claim 4, further comprising:
determining if a Negative Acknowledgement (NACK) message is received from a mobile station through a (t+1)^{th} frame; and
re-providing the multicast service provided through the t^{th} frame when the NACK message is received.

6. The method as claimed in claim 4, further comprising:
determining if a Quality-of-Service (QoS) indicator is received from the mobile station at every frame; and
when the QoS indicator is received, determining a service type by taking the received QoS indicator into consideration.

7. The method as claimed in claim 6, wherein the QoS indicator includes a parameter associated with at least one of channel state information, a data loss rate, jitter, and latency.

8. The method as claimed in claim 6, wherein the service type corresponds to one of the multicast service, unicast service, and broadcast service.

9. The method as claimed in claim 4, further comprising providing a unicast service to each of the one or more mobile stations, which has requested the multicast service, when the determined number of mobile stations is less than the preset value.

10. A wireless communication system, the system comprising:
at least one mobile station for determining if a signal corresponding to a multicast service is received from a base station through a t^{th} frame, for transmitting a Negative Acknowledgement (NACK) message to the base station in a contention-based scheme through a (t+1)^{th} frame, if the signal corresponding to the multicast service is not received, for receiving a signal re-transmitted from the base station through a (t+2)^{th} frame, and for transmitting a Quality-of-Service (QoS) indicator to the base station in every frame when the downlink channel state is degraded below a preset channel state; and
a base station for receiving one or more multicast service request messages including downlink channel state information from the one or more mobile stations, for determining the number of mobile stations which have requested the multicast service, for determining a modulation and coding scheme (MCS) based on a mobile station, which has transmitted lowest channel quality information corresponding to the poorest channel state, among the one or more mobile stations when the determined number of mobile stations exceeds a preset value, and for providing the multicast service through the t^{th} frame by applying the determined MCS.

11. The system as claimed in claim 10, wherein the base station determines if a Negative Acknowledgement (NACK) message is received from a mobile station through a (t+1)^{th} frame, and re-provides the multicast service provided through the t^{th} frame when the NACK message is received.

12. The system as claimed in claim 10, wherein the base station determines if the QoS indicator is received at every frame, and determines a service type by taking the received QoS indicator into consideration when the QoS indicator is received, in which the QoS indicator includes a parameter associated with at least one of channel state information; a data loss rate, jitter, and latency.

13. The system as claimed in claim 12, wherein the service type corresponds to one of the multicast service, unicast service, and broadcast service.

14. The system as claimed in claim 10, wherein when the determined number of mobile stations is less than the preset value, the base station provides a unicast service to each of the one or more mobile stations, which has requested the multicast service.

15. The system as claimed in claim 10, wherein the at least one mobile station receives information about the preset channel state from the base station.
